(19) United States
(12) Patent Application Publication
(10) Pub. No.: US 2017/0322561 A1
(43) Pub. Date: Nov. 9, 2017

(54) ROBOTIC INVENTORY DISPENSARY OPERATIONAL ENHANCEMENTS

(71) Applicant: BBY SOLUTIONS, INC., Richfield, MN (US)

(72) Inventor: Chad Stiernagle, Eagan, MN (US)

(21) Appl. No.: 15/584,725

(22) Filed: May 2, 2017

Related U.S. Application Data
(60) Provisional application No. 62/330,941, filed on May 3, 2016.

(51) Int. Cl. G05D 1/02; B65G 1/137; G06K 19/07; G06Q 10/08; B65G 1/06; G06Q 50/28; B65G 61/00; B65D 21/02

(52) U.S. Cl. CPC G05D 1/0274; B65G 1/065; B65G 1/1378; G05D 1/0223; G05D 1/0246; G06K 19/0723; G06Q 10/0875; B65G 61/00; G05B 2219/31003; G05B 2219/31006; B65D 21/0235; G06Q 50/28; G05B 2219/31007

(57) ABSTRACT

The present application is directed to a robotic system for maintaining product inventory and dispensing products upon request from a customer or other user. Product items are stored within bins in an inventory storage unit, with respective sets of bins being hosted in respective storage cells of the inventory storage unit. As discussed herein, variety of sensors are designed to interface with robot operations of the inventory storage unit, to detect abnormal and error conditions, and to allow adaptation where possible to continue retrieval, access, and storage operations. As also discussed herein, operation of the robot may be controlled as a result of various user interface interactions, including interactions from remote computing devices such as smartphones and remote systems such as websites and inventory or retail management systems.

### CROSS-REFERENCE TO RELATED APPLICATIONS

The present application claims priority to United States Provisional Patent Application Ser. No. 62/330,941 filed May 3, 2016, and titled “ROBOTIC INVENTORY DISPENSARY OPERATIONAL ENHANCEMENTS”, which is hereby incorporated by reference in its entirety. The present application also includes subject matter related to the subject matter in: U.S. patent application Ser. No. 15/012,525, filed Feb. 1, 2016, and titled “Random-Access Robotic Inventory Dispensary: Operation Prioritization”; U.S. patent application Ser. No. 14/702,803, filed May 4, 2015, and titled “Random-Access Robotic Inventory Dispensary: Replenishment and Purge”; U.S. patent application Ser. No. 14/702,813, filed May 4, 2015, titled “Random-Access Robotic Inventory Dispensary: Multi-Pick Fulfillment”; and U.S. patent application Ser. No. 14/702,827, filed May 4, 2015, titled “Random-Access Robotic Inventory Dispensary: Variable Bin Height”; each of these applications are hereby incorporated by reference in their entirety.

### TECHNICAL FIELD

The present disclosure relates to a random-access robot-implemented inventory storage and dispensary system. Specifically, the present disclosure includes examples of technical enhancements to allow operational improvements of storage and retrieval operations in a designed robotic system.

### BACKGROUND

Many forms of robotic systems are used for inventory management, storage, retrieval, and dispensing purposes. For example, specialized robotic systems are used in some warehouse or commercial settings to retrieve products from storage shelves and units. Also for example, robotic systems are used in a retail setting to allow consumers or employees to select and dispense products from a retail inventory of saleable goods. Although many types and formats of robotic dispensing systems have been proposed in retail and commercial settings, the deployment of such systems is often limited by cost, space constraints, reliability, and the failure of existing systems to properly handle a variety of product types and use conditions.

### BRIEF DESCRIPTION OF THE DRAWINGS

FIG. 1 provides an overview of a robotic inventory dispensary system according to an example.

FIG. 2 is a block diagram illustrating functional and structural components of a robotic inventory dispensary system according to an example.

FIG. 3 is a conceptual diagram illustrating a storage hierarchy used in a robotic inventory dispensary system according to an example.

FIG. 4 is an illustration of sensors used in a robot product bin retrieval operation within a robotic inventory dispensary according to an example.

FIG. 5 is an illustration of sensors used in a robot product bin access operation within a robotic inventory dispensary according to an example.

FIG. 6 is a block diagram illustrating sensor operational tasks that may be performed with a robot system according to an example.

FIG. 7 is a flowchart illustrating a method for performing sensor operational tasks with use of a robot system according to an example.

FIG. 8 is an illustration of a scenario for user interface interactions with use of a robot system according to an example.

FIG. 9 is a block diagram illustrating user interface operational tasks that may be performed with a robot system according to an example.

FIG. 10 provides a flowchart illustrating a method for performing user interface operational tasks with use of a robot system according to an example.

FIG. 11 is a block diagram of a machine in the example form of a computer system within which a set of instructions, for causing the machine to perform any one or more of the methodologies discussed herein, may be executed.

### DETAILED DESCRIPTION

The present disclosure describes operational enhancements to a robotic inventory dispensary, such as a robotic system for maintaining product inventory and dispensing products upon request from a consumer. In a retail environment, a consumer might be a customer, a staff member, employee or contractor, another automated system, or another operator of the robotic inventory dispensary. As discussed herein, product items within the robotic inventory dispensary are stored in an inventory storage unit that is accessible by a robot, with at least one item per bin. Controller logic is used to operate the robot to allow product items to be stored in, and retrieved from, assigned storage locations of the inventory storage unit. Because contents of any storage location in the robotic inventory dispensary may be accessed by the robot directly at any time, the robotic inventory dispensary may operate in a random-access fashion.

As an example, random access operations performed by the robot with the robotic inventory dispensary may include, for example, coupling to (e.g., magnetically) and removing one or more bins from the inventory storage unit; removing a product item from a bin; placing a bin at a storage location in the inventory storage unit; transferring a bin from one location in the inventory storage unit to another location; transferring a product item from a bin to a dispensing apparatus (e.g., a dispensing chute, a conveyor, or an operator access device); transferring a bin from the operator access device into the inventory storage unit; and compressing a storage area within the inventory storage unit where bins are stored. The robotic inventory dispensary may perform these operations based on various logic and command specifications, including rules and conditions, mechanical constraints, and prioritization of operations. For example, a prioritization scheme may be used to govern the relative priority attached by the robot to the sequence of tasks that the robot is used to perform. The robotic inventory dispensary may perform these and other operations with the use of sensor-based conditions and processing, and as a result of multi-device user interface interactions, as discussed herein.

In the examples discussed herein, operation of the robot with product units involves repeated interaction with storage bins, which may be hung, suspended, or maintained within the inventory storage unit on rails arranged in a drawer-like fashion. The use and movement of these storage bins may lead to error conditions in the robotic inventory dispensary, due to human error or mechanical failure. For example, a storage bin that is filled incorrectly by a human user (e.g., with an oversized, overweight, or improper item) may cause a storage bin to become stuck or the product to become damaged. Likewise, human error, mechanical failure, or environmental conditions may lead to the movement and misaligning of storage bins that are stored in the inventory storage unit, resulting in issues when a storage bin is attempted to be accessed or retrieved. In the examples discussed herein, a variety of sensors are designed to interface with robot operations to detect abnormal and error conditions, and to allow adaptation where possible to continue retrieval, access, and storage operations.

Also in the examples discussed herein, operation of the robot may be controlled as a result of various user interface interactions, including interactions from remote computing devices such as smartphones and remote systems such as websites and inventory or retail management systems. Commands may be issued to the robotic inventory dispensary, for example, to perform a retrieval of an item previously purchased in another commerce channel through the use of a scanned QR code, device-to-device communication, or user identification of an associated purchase. Commands may also be issued to the robotic inventory dispensary to coordinate retail sales operations with a product showroom or point of sale systems, such as to reserve and retrieve a product from a storage location prior to a customer purchase in a retail store. Other commands may be issued to pre-fetch projected inventory, and to coordinate with retail sales operations of restricted (e.g., high-value, secure) products.

As used herein, a “user interface” (UI) refers to a human-controllable feature that allows a user to interact with a computer or processing system. A UI may contain a display, tactile controls, or peripheral devices (e.g., mouse, touch pad, joystick) to facilitate entering data and making selections. The processing system, under control of one or more computer processors, might provide a graphical UI (GUI) though the display. A GUI may or may not include touch controls. As discussed herein, the robotic inventory dispensary may feature or interface with multiple UIs that effect user control and operation of the dispensary.

As used herein, a “database” stores and organizes data in any number of file structures and tangible computer-accessible storage devices, in any format. A “database system” (and, indeed, a database) may be hierarchical, and include one or more databases, possibly of a variety of different contents, types, formats, and access means. For example, a database in a database system might be a relational database, an object-oriented database, a flat text file, or a collection of images or audio/video tracks. As discussed herein, the robotic inventory dispensary may feature or interface with multiple databases that produce data for control and operation of the dispensary.

As used herein, “logic” refers to hardware, and software instructions executing on that hardware, that executes instructions, makes decisions, and initiates actions. As discussed herein, the robotic inventory dispensary may feature or interface with multiple implementations of logic that define control and operation rules and conditions for the dispensary.

As used herein, a “robot” is an apparatus or system that performs physical tasks under control of a processing system or controller, which executes controller logic. Note that two robots, each with separate controllers, may be under common supervision or direction by a single controller. This combination of robots may be regarded as a single robot. Similarly, if robot A directs robot B, the combination of A and B may be regarded as itself a robot. In some instances, to emphasize that two or more robots might be involved, the term “robotic system” rather than “robot” may be used, although reference to a “robot” are not necessarily singular.

As used herein, a “scanning system” used with a robotic inventory system may include one or more scanners acting under a common control. Each scanner in the system may use a respective scanning technology, to scan specific types of objects, and obtain from those objects specific types of information. Between any two scanners in the system, the technologies used may be the same or different; the types of objects may be the same or different; and the types of information may be the same or different. A scanning system might or might not be integrated into a particular robot.

As used herein, a “product item” refers to an individual instance of a product model. A “product type” is a set of product items having something in common. The following are example product types: all product items of a given model or stock-keeping unit (SKU); all product items from a given manufacturer; all product items from a given supplier; all product items having a given functionality (e.g., video cameras): all product items of a given model having a particular color; all product items of a given variety (e.g., freeze-dried strawberries) and shelf-life or sell-by date; a set of individually-identified product items.

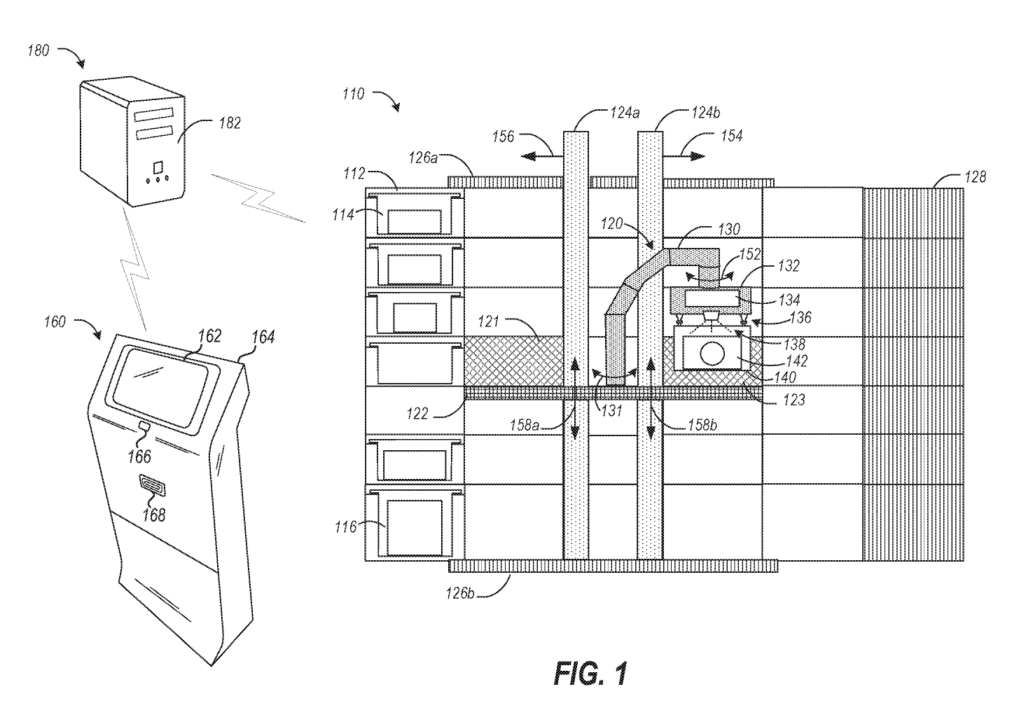

FIG. 1 provides an overview of a robotic inventory dispensary system according to an example. As shown, the robotic inventory dispensary system includes a storage unit 110 (e.g., an inventory storage unit) for storing various product items; a consumer kiosk 160 (e.g., including a computer unit 164 featuring a UI 162, input sensor 166, and payment input device 168) for providing requests to obtain and access various product items; and a controller 180 (e.g., including an electronic control system 182) for issuing commands to the robotic system operating on the storage unit 110, that perform the storage, retrieval, and access of the various product items. It will be understood that the robotic inventory dispensary system may include additional systems and functions to implement the enhancements and functions described herein.

FIG. 1 provides a front view of a robot 120 adapted to operate on the storage unit 110 of the example robotic inventory dispensary. The depicted storage unit 110 is arranged into a module that is a grid six columns wide and seven rows high. The leftmost column 112 is shown as including a series of cells that host respective storage bins (containers), such as storage bin 114 in the upper-left cell and the storage bin 116 (e.g. a larger-sized storage bin) in the lower-left cell. The rightmost column 128 is reserved for empty bin storage, and is shown shaded. In an example, where product items may be marked with optical-type identifiers (IDs), such as a barcode or 2D barcode included on the product or product packaging, then the respective bins may be transparent, or translucent, on all sides, to allow scanning of product items within the bins. The storage unit 110 may have a rigid structure and have essentially the shape of a rectangular grid, although other forms and shapes may be used.

The robot 120 accesses storage cells of the storage unit 110, and bins (such as storage bin 114 or storage bin 116) that are suspended, hosted, hung, maintained, or otherwise located within the storage cells. The illustrated robot 120 includes an articulated arm 130. As illustrated, the arm 130 can swivel, tilt, and bend; a hand 136 of the arm can couple to, lift, and move bins (such as the storage bin 140, shown as being removed from the storage unit). The robot 120 may include a shelf 122 onto which it can slide out one, two, or more trays on either side of the arm 130 (e.g., into storage cell 121 or into storage cell 123) in order to insert, remove, rearrange, or compress bins into, from, and within a particular storage cell. The shelf 122 can move vertically along one or more posts 124 as indicated by arrows 158a, 158b; the robot 120 illustrated in FIG. 1 has two posts 124a, 124b. The posts 124a, 124b move left/right along one or more tracks, as indicated by arrows 154, 156; the robot 120 illustrated in FIG. 1 has a track 126a at the top and another track 126b at the bottom, but other arrangements for horizontal or vertical movement are possible.

In an example, the arm 130 of the robot 120 has a base that can swivel as indicated by arrow 131. The arm 130 may provide a segment 132 from which a grabber, gripper, or the hand 136 is suspended. The hand 136 can grab, grip, attach, lift, and translate bins, and can open and close drawers provided by the trays. The robot 120 may include segments that can tilt relative to each other and also relative to the base. Thus, the arm 130 may swivel, bend, and tilt to give the hand 136, which can itself rotate as indicated by arrow 152, a wide range of positions and orientations. The segment 132 of the arm 130 may include a display screen 134 or other output device used to provide an indication of operation. The arm 130 may also include an extensible or telescopic segment (not shown), such as in the base, that allows it to move vertically. In the configuration of FIG. 1, the arm 130 moves vertically along with shelf 122 but may be repositioned with translation and rotation mechanisms to provide four, five, or six degrees of freedom (or more). Other configurations of the robot 120 and, in particular, of the arm 130, can provide similar functionality and may be used with the presently disclosed techniques.

In another example, the horizontal and vertical motion of the shelf 122 and arm 130 may be handled by a robot or other mechanical system that is separate from the robot 120 but that accesses storage cells and moves bins. However, such robots or mechanical systems may be under common control of the electronic control system 182, and so may be considered a single robot or robotic system.

As further shown in FIG. 1, the robotic inventory dispensary is adapted to perform various sensing and verification operations when retrieving or accessing a product item 142 and the accompanying retrieved storage bin 140. These sensing and verification operations may be performed with the use of a sensor 138, such as an optical vision sensor used to capture an image of the product item 142, the storage bin 140, and a surrounding environment. For example, the optical vision sensor may be used to verify that the storage bin 140 is undamaged and contains the product item 142. The optical vision sensor may also be used to assist the coupling of the hand 136 to the storage bin 140, or to verify that the storage bin 140 is in a condition for movement by the hand 136 or manipulation by the arm 130. Other sensing and verification operations may be performed based on the techniques further discussed herein.

Thus, the robotic inventory dispensary depicted in FIG. 1 stores and dispenses product items stored in various bins and storage cells to consumers. As summarized by FIG. 1, a user of the robotic inventory dispensary might be a consumer, an operator, or a service technician. An operator might handle manual aspects of product replenishment or purge. A service technician might access the system for testing, upgrade, or repairs. Thus, as used herein, the term “consumer” is not necessarily an economic consumer, but rather as a consumer of the primary function of a robotic inventory dispensary; namely, dispensing product items on demand. For example, a consumer might be a staff member or a customer. A consumer might also be another automated system. A staff member might be, for example, a person who fulfills orders within a retail store or a distribution center (DC). A person might be a user both as an operator and as a staff member. In an example, the robotic inventory dispensary may dispense product items directly to customers in a store. In some examples, an operator might also be a consumer.

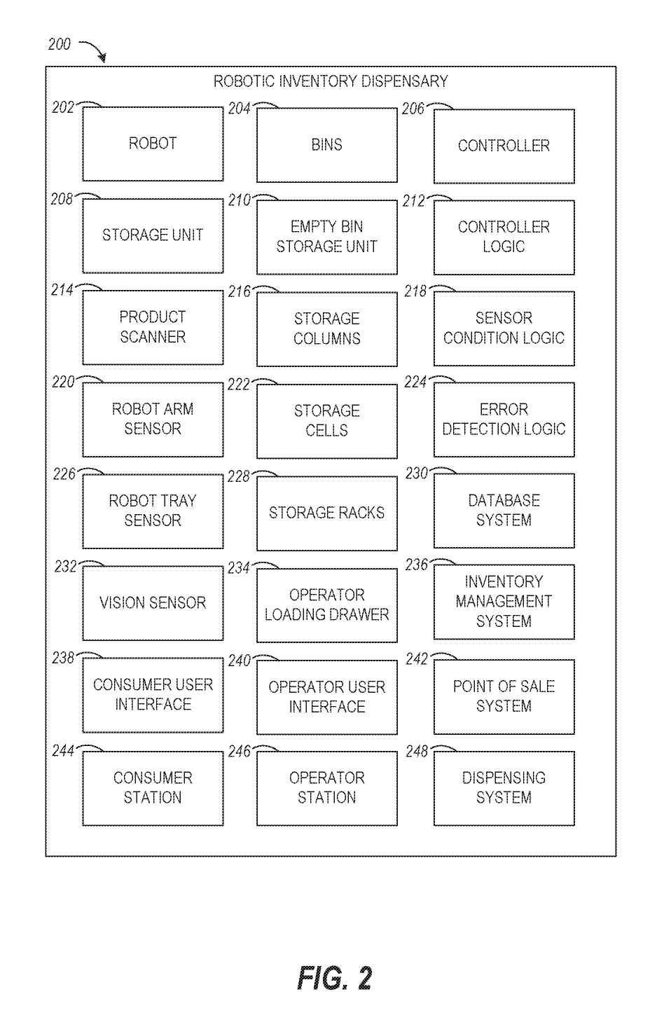

FIG. 2 illustrates a block diagram featuring example functional and structural components of a robotic inventory dispensary 200 system. A robot 202 stores product items in bins 204 within a storage unit 208 under the management of a controller 206. As previously discussed, the storage unit 208 may be organized into multiple storage columns 216 having multiple storage cells 222, with each of the storage cells providing respective storage racks 228 to host the bins 204. The storage unit 208 of a robotic inventory dispensary 200 thus may be implemented through one or more modular units or housings; one or more robots 202; access by one mechanism or several mechanisms, or one or more locations. For example, a robotic inventory dispensary 200 might dispense product items to customers, but also dispense product items to staff members using a different robot 202 and at a different location, such as in a backroom of a store or at a point of sale location. The robotic inventory dispensary 200 may also integrate its product item information and its database system 230 with use of an inventory management system 236, such as provided in an information system maintained by a retail store or distribution center. The robotic inventory dispensary 200 may include a dispensing system 248 such as dispensing chutes at multiple locations; for example, a chute in front of the storage unit 208 for customers and another behind the storage unit 208 for staff members. The dispensing system 248 may also include a chute for dispensing product items to an operator.

Within the storage unit 208, product items may be stored in the bins 204, such as one product item per bin. A set of the bins 204 may be organized on a particular set of storage racks 228 in the storage unit 208, with the particular rack and configuration establishing respective storage cells in a plurality of storage cells 222 in the robotic inventory dispensary 200. A storage cell may be a frame structure, or it might have one or more solid sides. The robot 202 may operate a tray or drawer feature, which is movably positioned into a set of bins 204 maintained in a particular storage rack in a particular storage cell in a particular one of the storage columns 216, providing the robot 202 access to the contents of the bins 204. As depicted in FIG. 1, a shelf of the robot 202 may include two such trays, left and right, that extend into the storage cells 222 and retrieve a specific set of bins 204, but other numbers of trays are possible. The trays provide are examples of temporary bin-holding receptacles. As discussed herein, the robot tray sensor 226 may operate to sense operations performed with the tray on a plurality of bins 204, such as to detect a misaligned or improper object within the plurality of bins 204; misalignment of the plurality of bins 204; and other conditions that may prevent proper storage, retrieval, or access to a particular product item.

The storage unit 208 may include or be located proximate to a section (e.g., a column) of an empty bin storage unit 210 used to operate empty bins. The controller 206 commands one or more robots 202 as its agents to move bins 204 and product items throughout the robotic inventory dispensary 200 as needed to implement the tasks of the controller 206, including the maintenance of bins 204 once product items are removed.

An operator may manually add or remove product items in the robotic inventory dispensary 200 through an operator access system, such as an operator loading drawer 234 accessible at an operator station 246. Components of the operator access system may be controlled by an operator UI 240 such as to allow commands to cause replenishment, purge, and related loading or unloading operations. Access by the operator to product items may occur with an operator loading drawer 234, another access mechanism, a conveyor, or the like. The robotic inventory dispensary may include more than one operator loading drawer 234 to improve efficiency. During replenishment, for example, the robot 202 might be removing already filled bins 204 from a first operator loading drawer while the operator fills another set of bins 204 in another. The operator loading drawer 234 is one example of an operator-access device, and it will be understood that other types of devices may provide an operator with access to the bins 204 for manual or human-assisted tasks.

The controller 206 may further move the bins 204 to the operator loading drawer 234 for loading and unloading of particular product items. In the operator loading drawer 234, an operator (e.g., an employee) may be provided with access to the bins 204 to assist in replenishment/purge operations regarding product items in the robotic inventory dispensary 200. In an example configuration, when the operator loading drawer 234 is opened, it projects out from a side of the storage unit 208, giving access to the operator to insert bins 204 or product items, and to remove bins 204 or product items. When the operator loading drawer 234 is closed, it behaves as a storage cell of the storage unit 208, providing the robot 202 access to the operator loading drawer 234 and its contents. Other features may be implemented in place of the operator loading drawer 234, such as a conveyor, insertion slot, or other loading area. The operator station 246 may include an operator UI 240 whereby the operator can interact with the controller 206 by entering data and instructions, and by receiving information.

The controller 206, executing controller logic 212 (e.g., provided from software, firmware, and electronic control commands), manages equipment such as the robot 202 and accesses and maintains data necessary to carry out tasks of the robotic inventory dispensary 200. The data may be saved in, and accessed from, a database system 230. The controller 206 may also implement sensor condition logic 218 and error detection logic 224 used to process data from a variety of sensors used in the operation of the robot 202 and other components of the robotic inventory dispensary 200. For example, the sensors monitored by the sensor condition logic 218 may include a robot arm sensor 220 that is coupled to or integrated with a robot arm of the robot 202, or a robot tray sensor 226 which is coupled to or integrated with a tray feature of the robot 202. For example, the robot arm sensor 220 may be used to detect a condition and an error state of one or more storage bins 204 as a retrieval or storage operation is occurring; the robot tray sensor 226 may be used to detect a condition or an error state of a set of bins 204 in a particular cell of the storage cells 222 or upon the storage racks 228; the vision sensor 232 may be used to detect a condition and an error state of components of the robot 202, the bins 204, the storage columns 216, the storage cells 222, the storage racks 228, the operator loading drawer, 234, or like components of the robotic inventory dispensary 200.

The robotic inventory dispensary 200 can vary the implementation of controller logic 212, sensor condition logic 218, and error detection logic 224, such as to accomplish different types of goals or operating states. For example, a given system might be prioritized to keep all product items of a given model or product type in the same area of the storage unit 208. Another system might seek primarily to minimize empty space in the storage unit 208. Another system might be optimized to avoid retrieving, storing, or dispensing bins or products from such bins that are sensed to occur outside of normal operational parameters (and thus may fail to be properly stored, retrieved, or dispensed). Another system might be optimized to alert an operator of a sensed error condition or identified operational constraint, to allow manual correction of an improperly operating feature of the storage unit 208.

The controller 206 of the robotic inventory dispensary 200 may perform electronic operations based on the implementation of controller logic 212, sensor condition logic 218, and error detection logic 224 and the maintenance of data in the database system 230, to allow a single product item to be stored in, and removed from, multiple locations (e.g., any given location) within the storage unit 208. In other words, the robotic inventory dispensary 200 may operate as a random-access storage system. The robotic inventory dispensary 200 may use a product scanner 214, including one or more laser or optical scanners, to identify bins 204 and product items (including product items within the bins 204. The robotic inventory dispensary 200 may also use the vision sensor 232 (in addition to the robot arm sensor 220 and the robot tray sensor 226) to sense characteristics of the bins 204 and the product items, including identification and verification operations.

The operational priorities for the robotic inventory dispensary 200 may change over time due to empirical experience or changing circumstances or constraints. In a similar fashion, the sensor conditions and error conditions may also be adapted, such as to identify (and alert or ignore) particular sensed conditions. Such conditions may be displayed (and controlled) through the operator UI 240 or a consumer UI 238.

In an example, a prioritization scheme is used to allow product items of a given model to be removed on a first-in first-out (FIFO) basis. Other schemes, such as last-in first-out (LIFO), may also be used. In another example, a prioritization scheme might prioritize minimization of retrieval time, without regard to shelf life, such as having the robot 202 grab (i.e., couple to and lift) the product item closest to the current position of its hand. In still other examples, a prioritization scheme may be selected based on the operational status of the robot 202 or sensed conditions from operation of the robot 202 or the stage of the storage unit 208. For example, if it is detected that a product item in a particular set of bins 204 is misloaded or misaligned (such as through the use of sensors), the robot 202 may retrieve another instance of the product item from another location in the storage unit 208.

The robotic inventory dispensary 200 may include a consumer UI 238 in a consumer station 244, whereby a consumer may request a product item. A first consumer UI might dispense product items to customers; a second consumer UI might dispense product items to staff members. The robot 202 may transfer the product item to a delivery location in a dispensing system 248 such as a chute for dispensing it to a consumer at a consumer station 244. The robotic inventory dispensary 200 may also include a chute that dispenses product items into the operator station 246 for an operator.

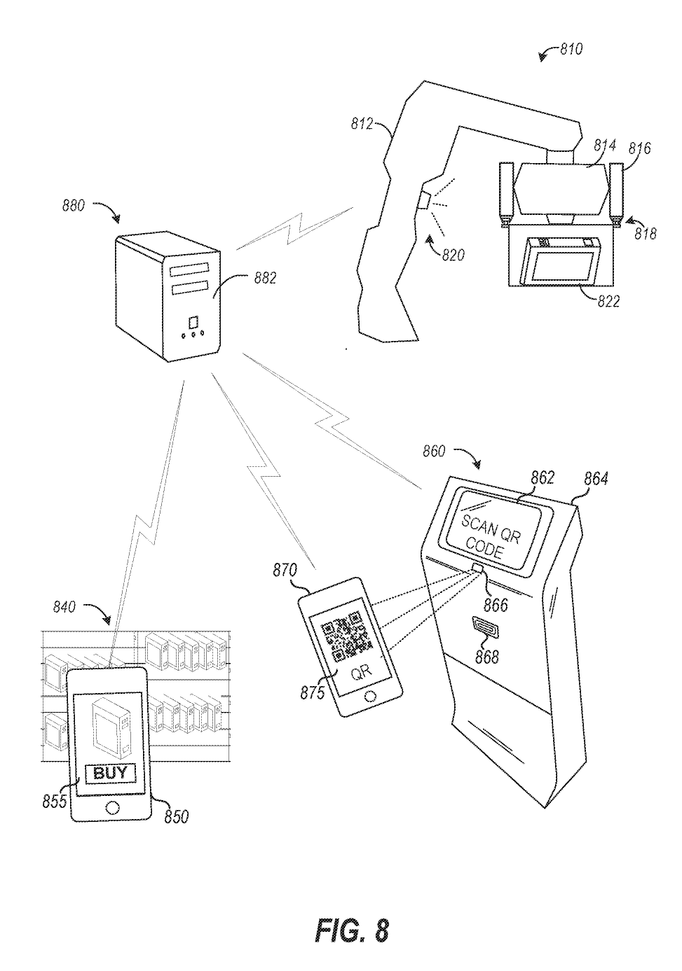

In some examples, the consumer UI 238 might act as, in effect, a smart vending machine. The consumer UI 238 might include a Point-of-sale (POS) system 242, requiring payment before a product item is delivered to the consumer. Such a consumer UI 238 may receive or accept various forms of payment, such as cash, credit card, or smart phone account scanning. The consumer UI 238 may also be used to enter or access payment data. In another example, the product items might be first delivered to the consumer without up-front payment. The consumer might then take the items to a separate POS station for payment and checkout. This approach might be appropriate where a store's inventory is split between the robotic inventory dispensary 200 and more traditional retail display units or showrooms, such as shelves, racks, and counters. As further discussed with reference to FIGS. 8-10, the robotic inventory dispensary 200 may operate in connection with omnichannel purchase scenarios, including kiosk-based pickup of items that are ordered on a mobile computing device.

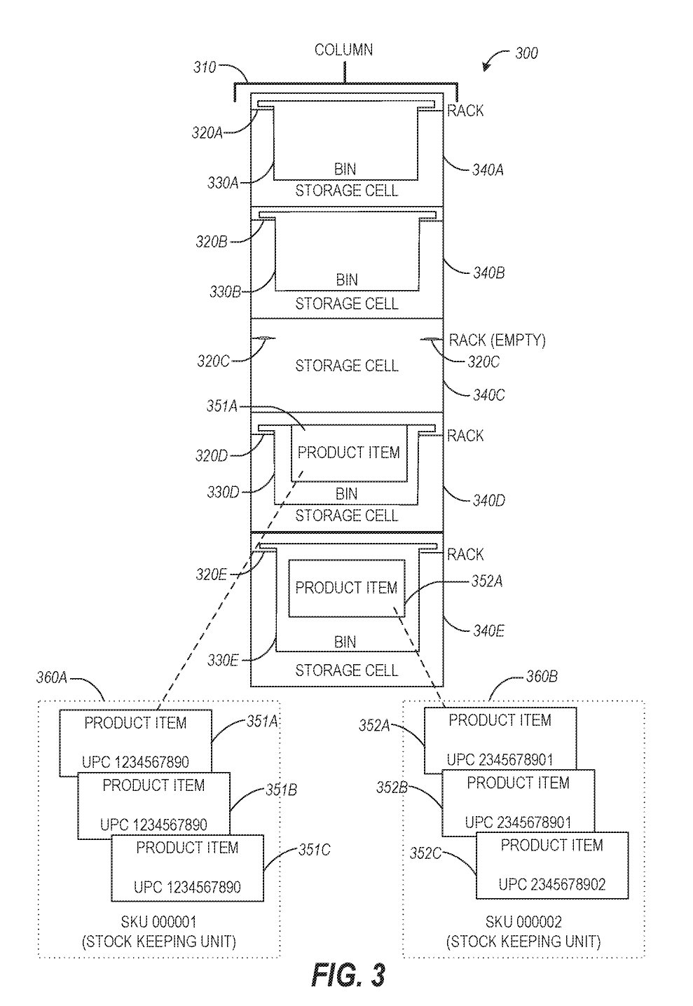

FIG. 3 provides a conceptual diagram illustrating a storage hierarchy used in an example storage unit 300 of a robotic inventory dispensary. As discussed herein, the storage unit 300 is organized into vertical columns, depicted with a storage column 310. Various sets of one or more storage bins are stored in respective storage cells (storage cells 340A, 340B, 340C, 340D, 340E), with the bins (such as bins 330A, 330B, 330D, 330E) being supported by racks (such as racks 320A, 320B, 320D, 320E, or empty rack 320C) arranged in the storage column 310. As FIG. 3 provides a front view of the storage unit, additional bins located in the storage unit behind the bins 330A, 330B, 330D, 330E are not visible, and additionally, storage cell 340C does not include a storage bin.

A tray or drawer feature of the robot may be extended into the storage cell by extension of the robot arm, causing access of (by lifting and moving) the respective sets of storage bins. In other examples, bearings or rollers (not shown) or other similar mechanisms may facilitate the removal and extension of a set of storage bins from the respective storage cell. The storage bins (bins 330A, 330B, 330D, 330E) may hang from two rails of a storage rack (racks 320A, 320B, 320D, 320E) by a lip structure, in a manner similar to well-known hanging file folders. Further, the storage bins (bins 330A, 330B, 330D, 330E) may have downward-extending pins that mate with holes in the rails, thereby ensuring proper alignment. The robot may use the pins to lift a bin, such as by magnetic attraction between the hand and the pins. The bins may have variable depths and/or heights. A bin may be empty (as shown with bins 330A, 330B), or may hold a product item (as shown with bins 330D, 330E).

FIG. 3 further illustrates the relationship between instances of product items (such as product items 351A and 352A) stored with various bins. As shown, product item 351A stored in the storage bin 330D may be one instance of multiple instances of the same product item, such as multiple copies of the product item having a common stock keeping unit (SKU) and universal product code (UPC) and that are stored within the robotic inventory dispensary. Thus, product items 351A, 351B, and 351C are different instances of the same product item, but are associated with a common UPC and SKU 360A. (Product items 352A, 352B, 352C are likewise associated with a common UPC and SKU 360B).

As also shown, the product item 352A stored in the storage bin 330E and the storage cell 340E may be one instance of multiple instances of the same product item having a common SKU but different UPC codes. This may occur in a scenario where a “limited edition” or “enhanced” version of the product item is sold under the same item SKU. In some examples, the robot system may track such specialized versions of the product item, and allow a user to purchase a specific version of a product item as kept within the storage unit. Other variations to product tracking based on SKUs, UPCs, and individual product instance identifiers may also be tracked in the robotic inventory dispensary system.

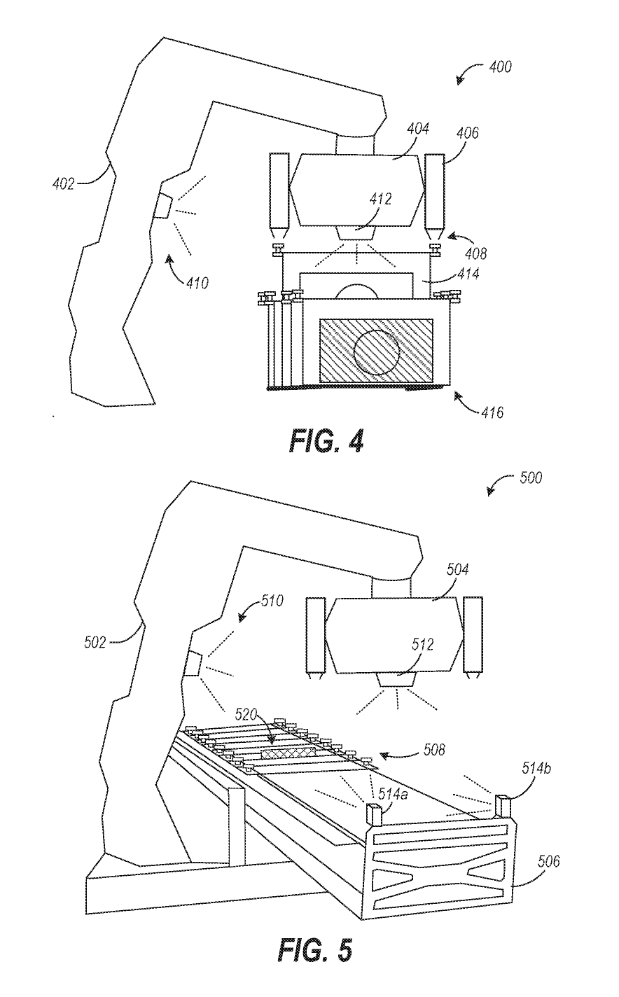

FIG. 4 is an example illustration of sensors used in a robot product bin retrieval operation within a robotic inventory dispensary. As shown, the robot 400 has operated its arm to move an arm operation unit 404 that includes a plurality of robotic hands 406 to retrieve a product bin. As shown, the robotic hands 406 have retrieved the storage bin 414 from a plurality of storage bins 416 (e.g., multiple bins retrieved from a storage cell or from an operator access device). The robot 400 operates one or more sensors 410, 412 to inspect the condition of the storage bin 414, the condition of the product item, and other characteristics of the components in the robotic inventory dispensary.

For example, a sensor 412 mounted to the arm may detect whether the robot arm can successfully operate, and whether the plurality of storage bins 416 are accessible or in a condition for retrieval, storage, or manipulation. The sensor 412 also may be used to position the arm operation unit 404 for retrieval of the storage bin 414, or to guide the arm operation unit 404 or the robotic hands 406 such as to grab a particular location 408 of the storage bin 414. The sensor may be used to detect a state and condition of the product item. As another example, a sensor 410 mounted to the robot base 402 (or in like positions on the robot platform) may be positioned to capture a view of the plurality of storage bins 416 and identify error states and conditions (such as a set of product bins in need of compaction or moving).

FIG. 5 is an example illustration of sensors used in a robot product bin access operation 500 within a robotic inventory dispensary. In a similar fashion to FIG. 4, the robot 502 includes a robot-mounted sensor 510, such as a vision or environmental sensor that may be used for detecting conditions of a plurality of product bins, the state of the storage unit, and the environmental state for robotic operations. The robot 502 also includes a robot arm-mounted sensor 512 located at an extension of the robot operation unit 504, such as a vision or environmental sensor that may be used for detecting conditions of the individual product bins, individual product items, and operations occurring with each.

FIG. 5 also depicts additional sensors 514a, 514b being coupled with a tray 506 of the robotic inventory dispensary that is moved with the platform of the robot 502. For example, the tray 506 may operate to be inserted into a storage cell holding a series of product bins 508 suspended by a storage rack; the tray 506 may remove the product bins 508 (e.g., by lifting and translating the product bins 508 in a direction). The sensors 514a. 514b may be used to assist the movement, insertion, and access of the product bins, such as to identify a condition where a product item 520 is extruded from (e.g., “sticking out” beyond) a normal loaded condition. In this fashion, the sensors 514a, 514b may be used to detect conditions where the storage bins are loaded incorrectly, where a product item has come loose or not inserted fully into a storage bin, and like conditions where the series of product bins 508 may not be manipulated or stored properly in the robotic inventory dispensary.

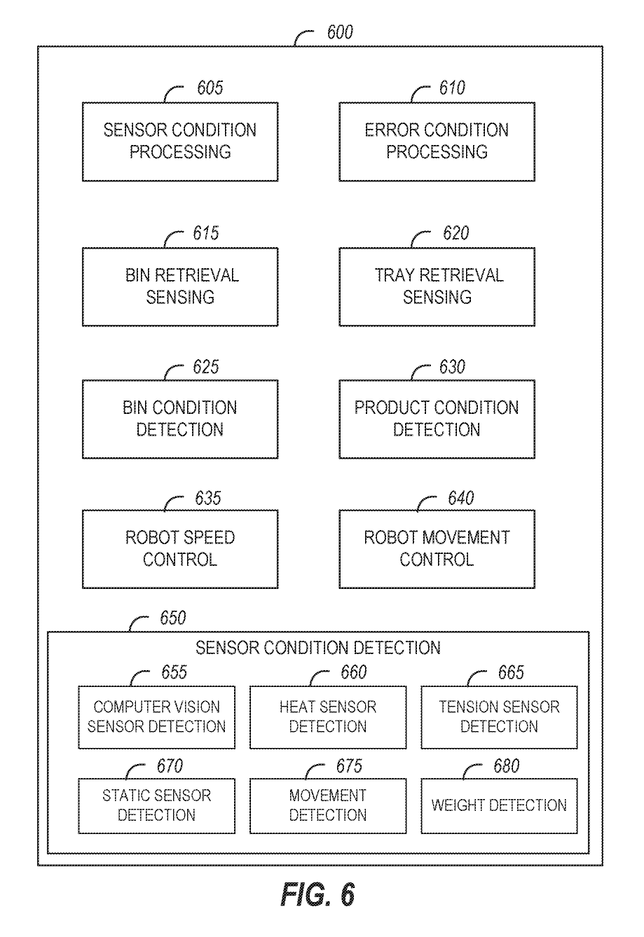

FIG. 6 is a block diagram illustrating sensor-related operational functions 600 that may be performed with a robot or robot system according to an example. These functions 600 may include one or more functions for: sensor condition processing 605, to detect certain operational conditions in the robotic inventory dispensary based on data from one or more of the sensors or sensor systems; and error condition processing 610, to detect error conditions based on data from one or more of the sensors or sensor systems. Further, these functions may be exposed through a user interface of an operator, a consumer, or a remote service, such as to provide an indication and control of sensor conditions.

The functions 600 may also include one or more functions for: bin retrieval sensing 615, such as to use sensor systems to assist the robot in identifying, accessing, and manipulating product bins and product items from the product bins, or to retrieve a product from a storage location; tray retrieval sensing 620, such as to use sensor systems to assist the robot in identifying product bin sets that are improperly loaded, misaligned, or inaccessible; bin condition detection 625, to establish logic conditions, rules, and results when certain environmental conditions (or internal properties) of the storage bins are detected, such as conditions that would prevent the robot from moving the storage bin; product condition detection 630 to establish logic conditions, rules, and results when certain environmental conditions (or internal properties) of the product item are detected, such as conditions that indicate damage to the product item or would result failure to properly dispense the product item.

The functions 600 may also include one or more functions for: robot speed control 635, such as to change the speed of movement of the robot, to prevent product damage, bin damage, or related operational failures in the robotic inventory dispensary; robot movement control 640, such as to change other movement characteristics of the robot to prevent product damage, bin damage, or to adjust storage or retrieval operations to increase operational efficiency and accuracy. The implementation of the robot speed control 635 and the robot movement control 640 may be based on product or storage bin characteristics (e.g., size, weight) that are stored in a database, detected with the sensors, indicated by a customer or operator, or the like.

In an example, the sensors used with the robotic inventory dispensary may include any number of electromechanical sensor detection functions 650 to detect environmental or object condition data. These may include: computer vision sensors for computer vision sensor detection 655; a temperature sensor for heat sensor detection 660; a tension sensor for tension condition detection 665; a static sensor for a static energy detection 670; a movement sensor for movement detection 675; a weight sensor for weight detection 680. Each of these sensors may correspond to conditions that interfere with proper operation of the robotic inventory dispensary (e.g., overweight product item from being stored or moved property; a misaligned bin being stored in the storage unit; excess movement by a product bin). Various conditions, errors, warnings, diagnostic messages, and like communications may be established to respond to such detected sensor data values.

In a further example, the sensor detector functions may be used to perform various verification and adjustment functions with the robot, such as to: determine whether one or more bins are loaded correctly, according to bin loading specifications; determine if a product is correctly placed in a storage bin type, based on dimension (height, width, depth) and weight specifications; determine whether bins are warped, malformed, or damaged; adjust a retrieval “grip” of the robot hand, including adjust the location of grip to match a location of the product gin; determine whether a product is incapable of being “dumped” or dispensed from a product bin, such as whether a product is stuck or compressed within a storage bin; determine whether the robot, a shelving unit, or a set of storage bins are off balance or misaligned.

Based on the sensor detection functions, remedial action may be taken where available, such as to recalibrate the system, or to take alternate action to prevent dispensing, storage, or retrieval failure. Likewise, actions to send a diagnostic message, perform additional diagnostics, disable a sensor, modify a control system setting, enact safety measures, or the like may be used in response to a detected failure event or the detection of certain sensor detection functions.

In an example, one or more of the electromechanical sensor detection functions 650 may be performed to verify human or manual activities with the robotic system, such as in response to a human operator loading a product into a storage bin and placing the storage bin in an operator loading drawer of the robotic inventory dispensary. The sensors (e.g., a computer vision sensor) may evaluate whether any product has been loaded into the storage bins incorrectly, and perform a test to verify that the dimensions of the respective products do not stick up above the height of a respective storage bin. If the verification does not occur (e.g., an error condition is detected), the robotic system may not allow the human operator to proceed with further loading of the bins (or moving onto the next step of robotic operations) until the error condition is corrected. The sensors may also evaluate other aspects of the storage bins during bin loading and like human or manual activities, such as the use of the computer vision sensor to detect warped bins, bins missing a barcode or an identifier sticker, broken bins, broken products, missing or dislodged products, and the like.

In a further example, the robot speed control 635 may be further based on one or more fragility or stability characteristics of the product item as determined from a product information database or from sensors (e.g., weight sensors) that evaluate the product item. For example, a product that is known to be fragile (e.g., including sensitive electronics, or including a glass screen) may be handled at a lower speed, or dispensed into an alternate delivery mechanism (e.g., not dumped into a chute). A product that is known to be fragile, heavy, or unstable may also transported at a lower speed than smaller, stabile items. Also for example, certain products associated with certain SKUs, UPCs, or other identifiers may be identified by the robot system as fragile, overweight, or sensitive products.

In still a further example, the robot speed control 635 may be further based on the type or classification of a product item, sensed environmental conditions (e.g., temperature), known issues with certain bins, bin types, and product types, or the product condition of a particular product item (e.g., if a damaged or an open-box item). Further, the robot speed control 635 may be based on usage or customer traffic patterns, such as in the scenario where the robot increases speed to operate faster during times of peak usage, or to decrease speed (and increase precision) during times of reduced usage.

Additionally, the robot speed control 635 may automatically reduce the speed of the robot when an error condition is detected or when certain operational parameters of the robot are outside of an expected range. Other similar variations to more effectively (and accurately) handle the product item, the storage bin, or a set of storage bins may also occur based on detected conditions in operation of the robotic system.

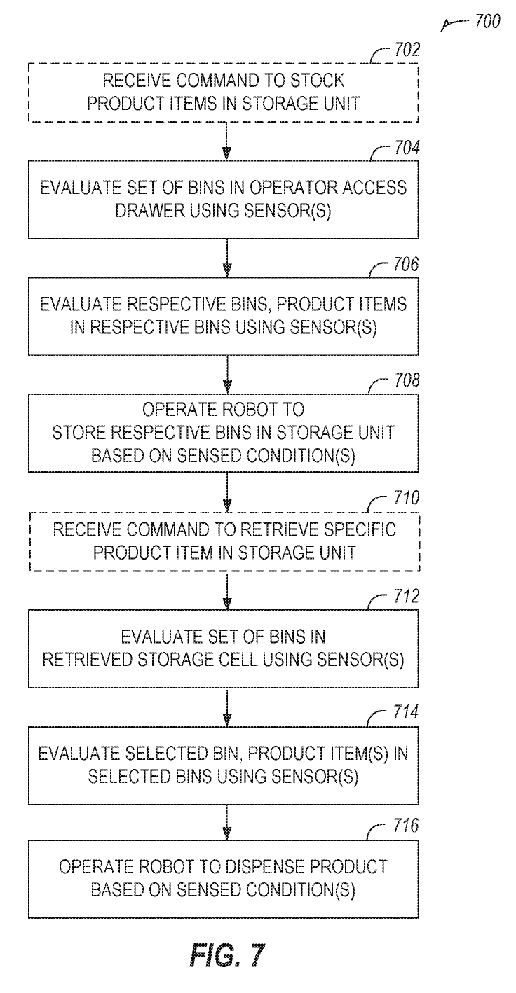

FIG. 7 is a flowchart 700 illustrating a method for performing sensor operational tasks with use of a robot system according to an example. As depicted, the flowchart 700 includes operations performed with the robot and sensors to evaluate and respond to robotic operation conditions. These operations may occur during product item storage (e.g., product stocking) operations, and during retrieval (e.g., product dispensing) operations.

For example, during product item storage operations, the robotic inventory dispensary may receive and process a command to stock product items in a storage unit (operation 702), and perform sensor evaluation operations in response to this command. The sensor evaluation operations may include an evaluation of a set (e.g., drawer) of multiple bins in the operator access drawers, using sensor data captured from the sensors (operation 704). The sensor evaluation operations may further include an evaluation of respective bins and product items in the respective bins, using sensor data captured from the sensors (operation 706). Based on the sensed conditions, the robot is operated to store respective bins in the storage unit (operation 708). If the sensed conditions indicate an error, then the robot may be placed in an alternate mode, the storage operation may be aborted or changed, an operator may be alerted, or the like.

Also for example, during product item retrieval operations, the robotic inventory dispensary may receive and process a command to retrieve a specific product item in the storage unit (operation 710), and perform sensor evaluation operations in response to this command. The sensor evaluation operations may include an evaluation of a set of bins retrieved from a storage cell using the sensor (operation 712), such as to determine if any of the bins are misaligned, damaged, or inaccessible. The sensor evaluation operations may further include an evaluation of a selected bin from the set of bins, such as a selected bin that includes a particular product item (operation 714), to determine if the product item is accessible and dispensable from the storage bin. Based on the sensed conditions, the robot is operated to retrieve the product bin and dispense the product item (operation 716). If the sensed conditions indicate an error condition, then the robot may be placed in an alternate mode, the retrieval may be aborted or changed, an operator or consumer may be alerted, or the like.

FIG. 8 is an example illustration of a scenario for user interface interactions with use of a robot system. As shown, a variety of electronic communications are provided among a robot 810, a controller 880, a consumer station 860, and smartphone 870 and smartphone 850. It will be understood that additional electronic communications and devices may be used to implement the following user interface interactions.

As shown in FIG. 8, an electronic commerce activity may occur in a retail environment 840 with use of the smartphone 850. For example, a user interface 855 may allow a customer to purchase or reserve a product item that is being evaluated or viewed in the retail environment. Based on this commerce activity, an electronic communication may be provided to the electronic control system 882 of the controller 880, to reserve, obtain, or perform other actions with the product item inventory of the robotic inventory dispensary action. For example, the electronic control system 882 may command the robot 810 to move the product item from a storage unit to a particular (e.g., temporary) holding area; or, the electronic control system 882 may reserve inventory for the product item in a database from further retrieval or access until the order is fulfilled or cancelled.

As also shown in FIG. 8, the smartphone 870 (which in some examples, is the same device as smartphone 850) may be used at a consumer station 860 to perform a retrieval of the product item from the robotic inventory dispensary. For example, the smartphone 870 may provide a user interface output 875 with a QR code, barcode, or other identifier to allow identification of the product item reservation or product item order at a customer kiosk 864. The customer kiosk 864 may operate to display a user interface 862 to instruct the user to present the identifier, and use a scanner 866 to optically read the identifier from the smartphone. Other forms of electronic communication such as Wi-Fi, NFC, and Bluetooth communications may also be used to communicate this information from the smartphone 870.

If the product item has been previously purchased, the robot 812 may operate to retrieve the product item 822 and dispense it to a location at or near the consumer station. If the product item has been reserved but not yet purchased, the robot 810 may operate to retrieve the product item 822 after payment is presented with the smartphone 870, with a payment device 868, or after other electronic payment has occurred. The operations of the robot 812 to retrieve the product item 822 may occur with use of the sensor conditions and processing logic as previously described, such as the use of the sensor 820 to verify the state of the product item 822, to assist the robotic arm 814 and robotic hand 816 in coupling 818 to a storage bin for the product item 822, and like robotic operations.

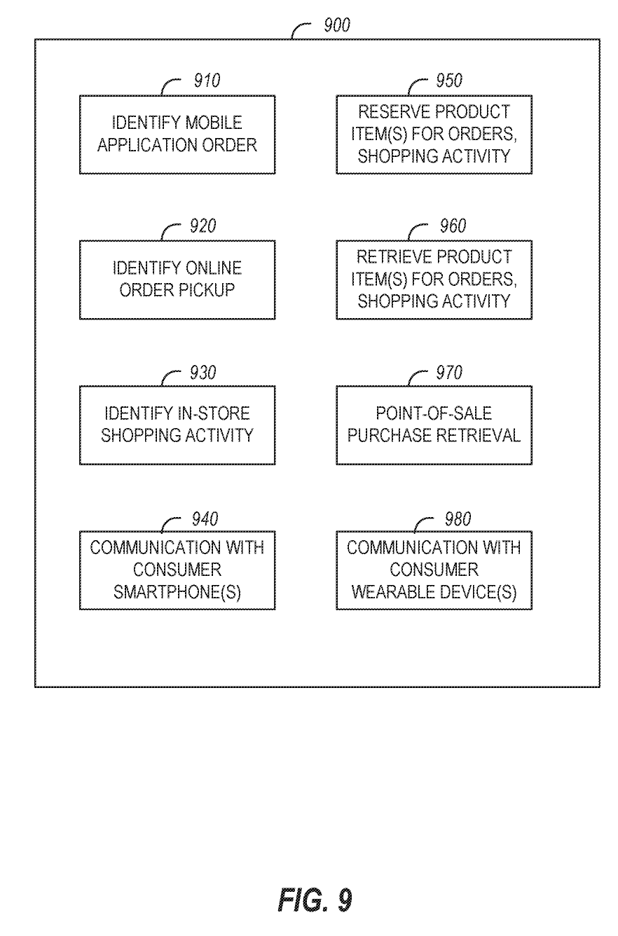

FIG. 9 is a block diagram illustrating user interface operational functions 900 that may be performed with a robot system according to an example. The operational functions 900 may be implemented through controllable features of the robot system, and features of a consumer station (e.g., customer kiosk) or an operator station (e.g., an employee control device), such as through user interfaces provided with one or more of the stations.

The operational functions 900 may include identifying a mobile application order 910. For example, a kiosk of the robotic inventory dispensing system may receive user identifying information (through automatic communication or manual input) to indicate that an item was previously purchased, reserved, or selected by the consumer in an application running on the consumer's mobile device, such as a smartphone app. The mobile application may provide (e.g., transmit, display) information to the kiosk of the robotic inventory dispensing system (e.g., through a wireless communication, through an encoded barcode, or the like) to indicate the order and customer identifying information. The operational functions 900 may further include related functions for identifying an online order pickup 920. For example, the kiosk of the robotic inventory dispensing system may receive user identifying information (through automatic communication or manual input) to indicate that an item was previously purchased, reserved, or selected by the consumer in an electronic commerce website (such as with a device that is not in proximity to the kiosk).

The operational functions 900 may further include identifying in-store shopping activity 930 and performing activities in the robotic inventory dispensing system in response to the shopping activity. For example, the robotic system may reserve and pull a product item for a particular product or product category based on a consumer's shopping activity in a retail environment (such as whether they evaluate or inquire about a specific product item, scan a specific product item on a display shelf, etc.). The robotic system may automatically offer an item for sale or retrieval to the consumer (e.g., through the consumer kiosk user interface), based on this consumer's shopping activity or prior shopping activity. Likewise, the operational functions 900 may further include coordinating point-of-sale activities with robotic operations 970, such as the manual or automatic retrieval of products in response to purchase activities occurring at a point-of-sale system (e.g., checkout or sales location of a retail space).

The operational functions 900 may further include robotic operations that are performed within the robotic inventory dispensary in response to detected commerce activities. These may include functions to reserve one or more product items for product item orders or shopping activity 950, and functions to retrieve one or more product items for product item orders or shopping activity 960. For example, reservation operations may be used to hold or reserve a specific product item in the inventory of the storage unit, based on a customer's shopping activity (e.g., to view or evaluate specific products in the retail environment) near or in proximity to the robotic inventory dispensary. Also for example, retrieval operations may be used to retrieve a specific product item from the inventory of the storage unit based on purchases occurring in the retail environment near or in proximity to the robotic inventory dispensary. These shopping activities and purchases may be real-world activities (e.g., product browsing, demonstrations, or interactions), or electronic activities (e.g., online and mobile app purchases, product research and searching).

The operational functions 900 may further include communication with a consumer's smartphone 940, or communication with a consumer's wearable device 980 (e.g., smartwatch), to implement any of the functions previously described. These communications may be performed with personal devices of the consumer, for example, for customer identification; communication of purchase or customer profile information; or product recommendations.

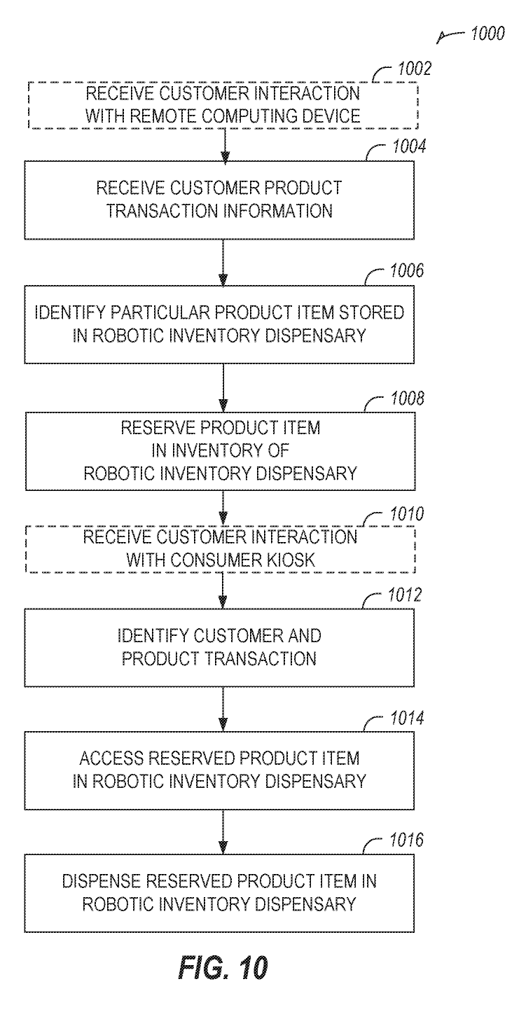

FIG. 10 provides a flowchart 1000 illustrating a method for performing user interface operational tasks with use of a robot system according to an example. The flowchart 1000 depicts a series of operations that occur as part of operations in the robotic inventory dispensary to reserve and dispense (e.g., retrieve) a particular product item. It will be understood that the operations of the flowchart 1000 may be applicable to the retrieval of multiple product items (such as in an order of multiple product items), and that the retrieval and reservation operations of the flowchart 1000 may occur with independent or combined transactions.

As shown in the flowchart 1000, the robotic inventory dispensary may interface with one or more systems (such as electronic commerce systems) that receive customer interaction with a remote computing device (such as a customer's smartphone) (operation 1002). This customer interaction may be communicated to the robotic inventory dispensary from the interfaced system (e.g., from the electronic commerce system, from a customer management system, or from an inventory management system). The information for the customer interaction may provide customer product transaction information that is received by the robotic inventory dispensary (operation 1004) about the particular product transaction (e.g., shopping activity, purchase, or the like).

The customer product transaction information may be used to identify a particular product item stored in the robotic inventory dispensary (operation 1006), and reserve the product item from the inventory of the robotic inventory dispensary (operation 1008). For example, the product item in inventory may be a specific instance of the product item that is stored in a particular storage location (e.g., cell) of the storage unit. This identified product item in inventory may be reserved from dispensing, or moved to a temporary holding location for later pickup.

At a subsequent time, a customer interaction will be received with a consumer kiosk of the robotic inventory dispensary (operation 1010), such as through the presentation of a customer identifier, a barcode, or other forms of an electronic communication. The robotic inventory dispensary will operate to identify the customer and the product transaction (operation 1012), such as by interfacing with an electronic commerce system. The identified product items for the transaction may be used to access the reserved product item (operation 1014) that has been reserved for the transaction in the robotic inventory dispensary. Finally, the reserved product item may be dispensed from the robotic inventory dispensary (operation 1016), which may be accompanied by other verifications of the product item, the customer, or payment method. In some examples, the reservation process may involve pre-payment of the product item from the electronic commerce system; in other examples, the reservation process may be followed by payment occurring at time of dispensing.

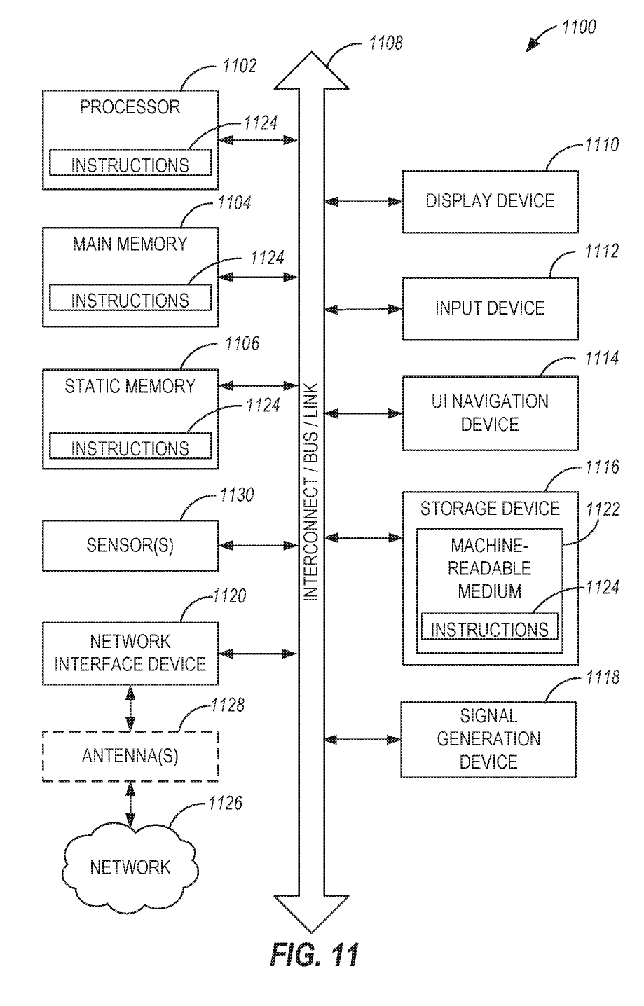

FIG. 11 illustrates a block diagram illustrating a machine in the example form of a computer system 1100, within which a set or sequence of instructions may be executed to cause the machine to perform any one of the methodologies discussed herein, according to an example. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a dedicated terminal (e.g., ATM unit), a personal computer (PC), a tablet PC, a hybrid tablet, a personal digital assistant (PDA), a wireless smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Although a computer is designated herein as one example of a specialized machine, it will be understood that other forms of electronic processing systems used in the robotic operation environment may operate as specialized machines in similar fashions.

Example computer system 1100 includes at least one processor 1102 (e.g., a central processing unit (CPU), a graphics processing unit (GPU) or both, processor cores, compute nodes, etc.), a main memory 1104 and a static memory 1106, which communicate with each other via a link 1108 (e.g., bus or interconnect). The computer system 1100 may further include a video display unit 1110, an input device 1112 (e.g., an alphanumeric keyboard), and a user interface (UI) navigation device 1114 (e.g., a mouse). In one example, the video display unit 1110, input device 1112 and UI navigation device 1114 are incorporated into a touch screen display. The computer system 1100 may additionally include a storage device 1116 (e.g., a drive unit), a signal generation device 1118 (e.g., a speaker), a network interface device 1120, and one or more sensors (not shown), such as a global positioning system (GPS) sensor, compass, accelerometer, location sensor, or other sensor.

The storage device 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104, static memory 1106, and/or within the processor 1102 during execution thereof by the computer system 1100, with the main memory 1104, static memory 1106, and the processor 1102 also constituting machine-readable media.

While the machine-readable medium 1122 is illustrated in an example to be a single medium, the term “machine-readable medium” may include a single medium or multiple media (e.g., a centralized or distributed database, and/or associated caches and servers) that store the one or more instructions 1124. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of well-known transfer protocols (e.g., HTTP). The communications with the communication network 1126 optionally may occur using wireless transmissions sent via one or more antennas 1128. Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above description is intended to be illustrative, and not restrictive. For example, the above-described examples (or one or more aspects thereof) may be used in combination with others. Other embodiments may be used, such as by one of ordinary skill in the art upon reviewing the above description. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A robotic inventory dispensary, comprising:
a robot;
a storage unit to store a plurality of storage bins in storage cells;
at least one sensor attached to the robot or the storage unit, the at least one sensor to provide sensor data related to characteristics of at least one storage bin in the plurality of storage bins; and
a controller to control operation of the robot upon the storage unit, wherein the controller is adapted to:
detect environmental and operational conditions of the at least one storage bin from the sensor data; and
control operation of the robot to access the at least one storage bin based on the environmental and operational conditions.

2. The robotic inventory dispensary of claim 1, wherein the at least one sensor is used to collect sensor data that indicates an error condition,
wherein the error condition relates to at least one of: an obstruction that prevents movement of the at least one storage bin, an obstruction that prevents movement of the robot, an unexpected object in a movement path of the robot, an unexpected object included in the at least one storage bin, an object missing from the at least one storage bin, a misalignment of the at least one storage bin in the storage unit, or an inability to retrieve the at least one storage bin from the storage unit, and
wherein the controller changes a location of the robot based on the error condition.

3. The robotic inventory dispensary of claim 1, wherein the at least one sensor includes a computer vision sensor adapted to capture an image of the at least one storage bin, and wherein the controller is further adapted to perform image recognition to identify an error condition in the robotic inventory dispensary based on the image of the at least one storage bin.

4. The robotic inventory dispensary of claim 1, wherein the at least one sensor includes at least one of: a computer vision sensor, a temperature sensor, a static sensor, a weight sensor, a tension sensor, or a pressure sensor.

5. The robotic inventory dispensary of claim 1, wherein the environmental conditions indicate a detected condition of a particular storage bin in the at least one storage bin, the detected condition relating to an interaction of the robot with the at least one storage bin, including at least one of: an improper weight, improper temperature, improper pressure, improper tension, improper size, an unexpected object, or a missing object.

6. The robotic inventory dispensary of claim 1, wherein the operational conditions indicate an operational condition of a robotic arm of the robot or an operational condition of the storage unit used to host the at least one storage bin, wherein the sensor data is processed to detect the operational conditions from sensor data that measures a set of observed operational parameters as being outside an range of expected operational parameters.

7. The robotic inventory dispensary of claim 1, further comprising a dispensary location, wherein the robot is further to couple to the at least one storage bin and attempt movement of the at least one storage bin from the storage unit to the dispensary location, wherein the sensor data is used to control speed, direction, or type of the movement of the at least one storage bin from the storage unit to the dispensary location.

8. The robotic inventory dispensary of claim 1, wherein the robot includes a robotic arm adapted for movement with at least three degrees of freedom, and wherein the operational conditions determined from the sensor data include monitoring the movement of the robotic arm in the robotic inventory dispensary.

9. The robotic inventory dispensary of claim 1, further comprising an output controller to issue an output to a consumer kiosk or an administrator station regarding an action that the robot is taking in response to the environmental and operational conditions determined from the sensor data.

10. A robotic inventory dispensary, comprising:
a robot;
a storage unit to store a plurality of storage bins in respective storage cells;
a consumer kiosk, the consumer kiosk including an input device to obtain an identifier of a product item and an output device to present a user interface that outputs a status of an attempted retrieval of the product item;
at least one sensor attached to the robot or the storage unit, the at least one sensor to provide sensor data of the attempted retrieval of the product item by the robot, wherein the attempted retrieval of the product item includes access to a location of a particular storage bin of the plurality of storage bins that hosts the product item and movement of the particular storage bin; and
a controller to control operation of the robot to interact with the storage unit, wherein the controller is adapted to:
select and reserve the product item stored in the particular storage bin based on the identifier of the product item;
control movement of the robot to obtain the product item from the location of the particular storage bin in the storage unit; and
detect environmental and operational conditions from the sensor data relating to the movement of the robot and attempted retrieval of the particular storage bin with the robot;
wherein the movement of the robot is further controlled by the controller in response to the detected environmental and operational conditions.

11. The robotic inventory dispensary of claim 10, wherein the input device includes a scanner to scan the identifier presented on an electronic device of a consumer user.

12. The robotic inventory dispensary of claim 11, wherein the identifier is presented in a QR code, wherein the QR code is provided to the electronic device of the consumer user in response to an electronic commerce activity corresponding to the product item, and wherein the scanner is used to obtain the identifier as presented on a display screen of the electronic device.

13. The robotic inventory dispensary of claim 10, wherein the environmental conditions relate to a detected condition of a storage bin, the detected condition relating to at least one of: an improper weight, improper temperature, improper pressure, improper tension, improper size, an unexpected object, or a missing object.

14. The robotic inventory dispensary of claim 10, wherein the operational conditions indicate an operational condition of a robotic arm or an operational condition of the storage unit used to host the plurality of storage bins, wherein the sensor data is used to detect the operational condition from sensor data that measures a set of observed operational parameters as being outside an range of expected operational parameters.

15. A method for operation of a robotic inventory dispensary, the robotic inventory dispensary including a robot, a storage unit to store a plurality of storage bins, at least one sensor, and a controller, and the method to perform electronic operations with the controller including:
receiving a request to move a particular storage bin of the plurality of storage bins from the storage, the particular storage bin to host a product item;
collecting sensor data from the at least one sensor to observe a state of the particular storage bin;
determining environmental and operational conditions of the particular storage bin from the sensor data; and
controlling operation of the robot upon the storage unit to attempt movement of the particular storage bin with the robot;
changing a movement of the robot based on the environmental and operational conditions determined from the sensor data.

16. The method of claim 15, the electronic operations further including:
receiving, from a scanner, an identifier presented on an electronic device of a consumer user;
selecting and reserving the product item stored in the particular storage bin based on the identifier of the product item; and
controlling movement of the robot to obtain the particular storage bin and the product item from a storage location of the particular storage bin in the storage unit; and
wherein the environmental and operational conditions determined from the sensor data relate to the movement of the robot and attempted retrieval of the particular storage bin with the robot.

17. The method of claim 15, wherein the at least one sensor includes a computer vision sensor, and the electronic operations further including:
capturing an image of the particular storage bin with the computer vision sensor, and
performing image recognition to identify an error condition in the robotic inventory dispensary based on the image of the particular storage bin.

18. The method of claim 15, wherein the environmental conditions relate to a detected condition of the particular storage bin, the detected condition relating to an interaction of the robot with the particular storage bin, including at least one of: an improper weight, improper temperature, improper pressure, improper tension, improper size, an unexpected object, or a missing object.

19. The method of claim 15, wherein the operational condition relates an operational condition of a robotic arm of the robot or an operational condition of a storage unit used to host the particular storage bin, wherein the sensor data is processed to detect the operational condition from sensor data that measures a set of observed operational parameters as being outside an range of expected operational parameters.

20. The method of claim 15, the electronic operations further including:
generating an output to a consumer kiosk or an administrator station regarding an action that the robot is taking in response to the environmental and operational conditions determined from the sensor data.
